(19) United States
(12) Patent Application Publication
(10) Pub. No.: US 2015/0129696 A1
(43) Pub. Date: May 14, 2015

(54) PARABOLIC VIBRATORY IMPACT MILL

(71) Applicant: TRANSMICRON LLC, Seattle, WA (US)

(72) Inventors: Vladimir Georgievich Andrienko, Moscow (RU); Alexandr Revazovich Merebashvily, Moscow (RU); Igor Nicolaevich Jartsev, St. Petersburg (RU); Victor Leonidovich Vasilev, Gatchina (RU); Valery Anatolevich Donchenko, Moscow (RU); Valery Andreevich Moiseev, Moscow (RU); Olga Alexandrovna Pirogova, St. Petersburg (RU)

(73) Assignee: TRANSMICRON LLC, Seattle, WA (US)

(21) Appl. No.: 14/405,004

(22) PCT Filed: Oct. 25, 2012
(86) PCT No.: PCT/RU2012/000869

§ 371 Date: Dec. 2, 2014

(51) Int. Cl. B02C 2/04

(52) U.S. Cl. CPC B02C 2/042
USPC 241/215

(57) ABSTRACT

A parabolic vibratory impact mill is proposed which comprises a housing having an outer cone, an inner cone and a power-operated vibrator. The shells of the cones have working surfaces in the form of parabolic generatrices: in the bottom part, the concavity of the parabolae is oriented toward the axis of the mill; in the top part, the convexity of the parabolae is oriented toward the axis of the mill. Conditions are created for the autogenous grinding of large pieces in the top part and small pieces in the bottom part, wherein the material partially decelerates in the transition region between the top parabolae and the bottom parabolae, providing for the metered feeding of the bottom region. The advantageous vertical distribution of the load in the grinding chamber provides a grinding ratio of 30 with little wear on the shells and low energy expenditure.

### PERTINENT ART

This invention relates to machines intended for fine crushing of minerals and plant origin materials.

### PRIOR ART

Production of cement and dry building mixtures is associated with high operation costs because the ball mills used for those purposes consume about 35 kWh per 1 ton of product with grain size finer than 0.071 mm. Furthermore, the wear of the grinding bodies' metal in that case is approximately 3 kg per 1 ton of product.

The expenses for crushing and grinding processes in the economical balance of a cement works represent 80% of all the costs. Therefore, to create mills that would allow energy and resource savings in this industry is a critical task for now.

In order to reduce energy costs, roller hydraulic presses are used prior to the mills, which bring about grinding of the clinker in the thick layer and reduce the total energy costs by 30%.

A new type of machine exists having high grinding ratios—about 15 on average. The grinding bodies of such machines are cones, while the inner cone is driven by a vibrator.

There is an inertia cone crusher (U.S. Pat. No. 4,592,517 dated Jun. 3, 1986), which comprises a case with an outer cone and a spherical support of an inner cone having a shaft and a bearing-mounted vibrator pivoted to the spherical support. Such a crusher's grinding ratio is not more than 10 because its vibrator is unable to develop high speed or substantial crushing force sufficient to obtain powders. This is explained by the fact that oil is fed into the vibrator's bearing from outside into the gap between the bearing bush and the cone's shaft, so that the outward centrifugal force hinders the oil from coming inside the gap. For this reason a crusher of that kind, in case of insufficient oil coming into the vibrator's bearing, may only operate for the production of stone chippings and is not able to act as a mill.

There is an inertia cone crusher (U.S. Pat. No. 4,655,405 dated Apr. 7, 1987), which comprises a case having an outer cone and an inner cone mounted on a spherical support and a shaft with a bearing-mounted driving vibrator which, in its turn, is driven by a counter-vibrator. The inner cone mantle profile is an approximated sphere while the outer cone mantle profile has a conical surface. The top part of said inner cone slows down the material feed, thus improving the grinding ratio. However, the incoming lump size in this case decreases by 30%, resulting in the same grinding ratio of the previous countertype equal to 10. This does not allow utilizing the said machine as a mill.

Both of the known machines provide intra-layer grinding of pieces of material by each other. However, the material inside the layer is crushed predominantly due to compression strain rather than due to shear strain. This is attributable to the geometry of the grinding chamber profiles, thus disallowing utilizing such machines as mills.

There is a prototypic parabolic vibration pulse mill (RF patent no. 2383390 dated Aug. 26, 2008) that comprises a case with outer cone and inner cone arranged on a spherical support with a shaft on which a drive vibrator is mounted with a bearing, generating lines of cone mantles in a lower part of the grinding chamber being parabolas while generating lines in a top part that are straight. Such design provided high grinding ratio—up to 20 due to shear strains of material layer not only in the horizontal plane but also in the vertical plane. However such complicated traveling motion of working surfaces resulted in almost doubled wear of mantles as compared to countertypes. Furthermore, material was entering the grinding chamber without slowing down and was repressing it, thus maintaining the said grinding ratio would require greater forces and, consequently, greater energy. Those drawbacks bring the obtainable advantages to a minimum.

### SUMMARY OF THE INVENTION

The objective of this invention is to design a vibration pulse grinding mill that will provide a grinding ratio up to 30 and will be capable of replacing a ball mill in closed cycle operations.

The said objective is achieved in a parabolic vibration pulse mill, which comprises a case with an outer cone accommodating an inner cone with a shaft running on a spherical bearing, with a drive vibrator mounted on said shaft with a bearing, while generating lines of said cones in a lower section of the grinding chamber represent parabolas, where in accordance with this invention concavities of said parabolas of generating lines of said cones in the lower section of the grinding chamber face the mill axis, and a top section of generating lines of the cones also represents parabolas with their convexity facing the mill axis, and conjugation of the parabolas is smooth.

The presented design provides conditions not only for compression of material layer in the charging zone but also for its shearing both in radial as well as tangential directions since the tangent lines at the center of the top parabolic generating lines do not cross the sphere center “C”. Such effect ensures a higher grinding ratio in the top zone as compared to the prototype. The top to bottom transition of the chamber provides possibilities to slow down the material flow, so the bottom zone is not repressed by the material, and the inner cone retains greater amplitude and crushing force with low wear of mantles. Therefore, an increase in grinding ratio up to 30 with low wear of mantles and lower energy consumption is ensured by means of the presented distinctive features.

### BRIEF DESCRIPTION OF DRAWINGS

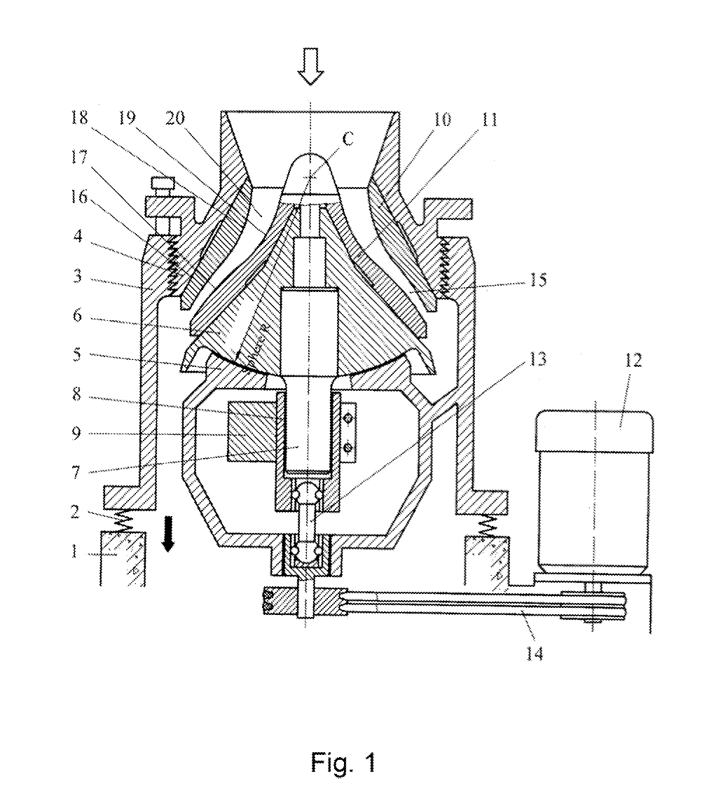

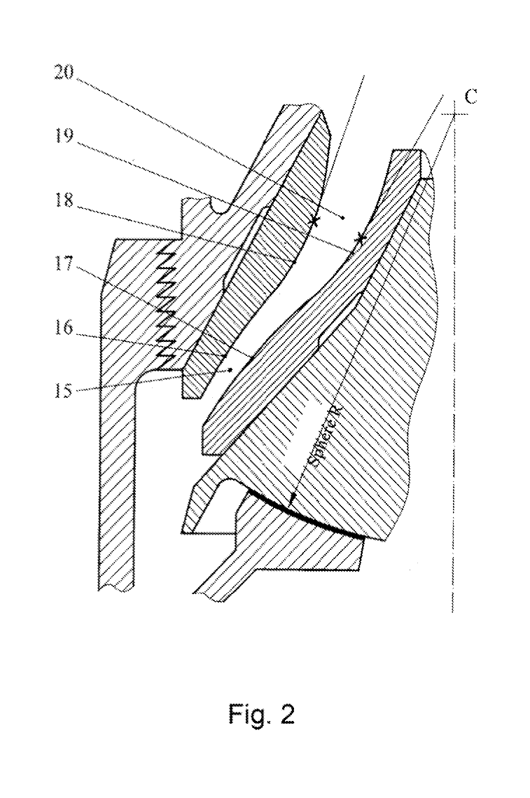

A longitudinal section view of the proposed mill is shown in FIG. 1 and a detail drawing of the grinding chamber is represented in FIG. 2.

### BEST MODE OF THE INVENTION

A mill comprises foundation 1 with resilient shock absorbers 2 supporting case 3 with outer cone 4 accommodating spherical support 5 and inner cone 6 with shaft 7 on which bearing 8 is installed holding vibrator 9. Cones 4 and 6 are fitted with mantles 10 and 11, respectively. Said vibrator 9 is connected to motor 12 by means of compensating shaft 13 and V-belt drive 14. Lower portions of mantles 10 and 11 form discharge zone 15 shaped up by parabolic generating lines 16 and 17 of said mantles with their concavities facing the mill axis. Top portions of mantles 10 and 11 have generating lines 18 and 19 represented as parabolas with their convexities facing the mill axis. The ends of said parabolas are smoothly conjugated.

The mill's operational principle is described below. From motor 12 via V-belt drive 14 and compensating shaft 13, torque is transmitted to vibrator 9, which rotates through bearing 8 on shaft 7 and creates centrifugal force inducing inner cone 6 to gyrate about center “C” of spherical support 5 of inner cone 6.

Material fed by gravity from a hopper to the grinding chamber formed by mantles 10 and 11 is crushed inside its own layer piece by piece through compression by approaching mantles 10 and 11 of cones 4 and 6. When material comes into charging zone 20 between parabolic generating lines 18 and 19, it undergoes not only compression but also shear both in radial as well as in tangential directions since the tangent lines in the center of the top parabolic generating lines do not cross sphere center “C”, which leads to shearing strains in the material layer and assures the effect of grinding big lumps, thus increasing here the grinding ratio. Certain slowdown of inner cone 6 due to said shearing strain also results in forward slip of vibrator 9 against the layer deformation plane. As resistance is reset, the vibrator approaches said plane, crushing force growing at the same time. Such force pulses occur approximately 60 times per revolution of the cone, resulting in intermittent layer strains and further increasing the disintegrating effect. Therefore, with the rotation speed of said vibrator 1000 revolutions per minute, which corresponds to the number of oscillations of said inner cone, there are 60 thousand pulses acting on the layer or 1000 pulses per second.

In transition to the lower part of said grinding chamber, the material is slowed down, providing loosening of the layer in the zone of the lower parabolic generating lines with their convexity facing the opposite side this time. Due to that the amplitude of said inner cone increases along with the crushing force. Therefore, also in the lower zone the grinding ratio remains high with low wear of the mantles.

Such active vibration pulse grinding effect of the layer allows obtaining more than 50% of finished grain size cement upon clinker crushing, which is close in performance to the ball mill yield. With that, however, energy consumption will be reduced by 10 times, while the wear of the grinding bodies will be 50 times lower.

Therefore, the distinctive features of this invention assure achievement of the said objective.

### INDUSTRIAL APPLICABILITY

This invention can be most widely used for production of construction materials such as cements.

1. Parabolic vibration pulse mill, comprising:
a case with cones fitted with mantles, the cones comprising an outer cone accommodating an inner cone with a shaft running on a spherical bearing, with a drive vibrator mounted on said shaft with a bearing;
wherein generating lines of said mantles in a lower section of a grinding chamber represent parabolas, and wherein the concavities of said parabolas of the generating lines of said mantles in the lower section of the grinding chamber face the mill axis; and
wherein a top section of generating lines of the mantles also represent parabolas with their convexity facing the mill axis, and wherein conjugation of the parabolas is smooth.
